(19) United States
(12) Patent Application Publication
(10) Pub. No.: US 2011/0021409 A1
(43) Pub. Date: Jan. 27, 2011

(54) Detergents and Cleaning Agents Comprising Porous Polyamide Particles

(76) Inventors: Bruce Cox, Scottsdale, AZ (US); Bernhard Banowski, Dusseldorf (DE)

Correspondence Address: Henkel Corporation, 10 Finderne Avenue, Suite B, Bridgewater, NJ, 08807, US

(21) Appl. No.: 12/854,204

(22) Filed: Aug. 11, 2010

Related U.S. Application Data
(63) Continuation of application No. PCT/EP2009/050399, filed on Jan. 15, 2009.

(30) Foreign Application Priority Data
Feb. 15, 2008 (DE) 10 2008 009 456.0
Feb. 15, 2008 (DE) 10 2008 009 457.9
Feb. 15, 2008 (DE) 10 2008 009 462.5

(51) Int. Cl. C11D 17/00; B32B 5/16

(52) U.S. Cl. 510/349; 510/438; 428/402

(57) ABSTRACT

Detergents and cleaning agents containing porous polyamide particles that allow larger amounts of liquids such as scented oil to be absorbed such that liquid active substances can easily be incorporated into corresponding detergents and cleaning agents. The porous polyamide particles allow the incorporated liquids to be released in a delayed manner.

### CROSS REFERENCE TO RELATED APPLICATIONS

The present application is a continuation of International Application No. PCT/EP2009/050399 filed 16 Jan. 2009, which claims priority to German Patent Application Nos. 10 2008 009 462.5, 10 2008 009 457.9, and 10 2008 009 456.0, all three applications filed 15 Feb. 2008.

The present invention relates to washing and cleaning agents such as textile washing agents containing porous polyamide particles. It also relates to a textile washing method and to use of porous polyamide particles in textile washing agents.

In the washing and cleaning agents sector there is a need for washing and cleaning agents containing particulate carriers capable of absorbing liquids such as perfume oils, and also storing them, depending on the application, and, if necessary, releasing them again, at best over a prolonged period.

Many different relevant models exist in the prior art. In general, specific core materials such as zeolites are impregnated with appropriate liquids (e.g., perfume oil). A system of this type is often also coated to prevent the undesirable leakage of the liquid.

However, there is still a need for appropriate washing and cleaning agents comprising particulate carriers capable of absorbing preferably large quantities of liquids, storing them securely, and releasing them again only after a time delay. The object of this invention was to satisfy this need.

Surprisingly, this object was achieved by the subject matter of the invention, which is a washing or cleaning agent containing
a) surfactant(s) and/or builders,
b) 0.0001 to 10 wt. % fragrance(s),
c) 0.1 to 10 wt. % spherical porous polyamide particles having
   a number-average particle diameter of 1 to 30 μm,
   a BET specific surface area (in accordance with DIN 66131) of 5 m²/g or more,
   an oil absorption capacity (boiled linseed oil) of 160 ml/100 g or more,
   a crystallinity (DSC measurement) of 40% or higher, and
   a quotient of volume-average particle diameter to number-average particle diameter of 1.0 to 1.5,
      wt. % based in each case on total weight of the agent.

The production of porous polyamide particles is disclosed, for example, in Japanese Patent Publication No. 2002-080629.

Agents according to the invention contain spherical porous polyamide particles having
a number-average particle diameter of 1 to 30 μm,
a BET specific surface area (in accordance with DIN 66131) of 5 m²/g or more,
an oil absorption capacity (boiled linseed oil) of 160 ml/100 g or more,
a crystallinity (DSC measurement) of 40% or higher, and
a quotient of volume-average particle diameter to number-average particle diameter of 1.0 to 1.5.

The spherical porous polyamide particles according to the invention can advantageously be incorporated without problems into various washing and cleaning agent matrices, even into liquid matrices.

Production of these spherical porous polyamide particles can generally take place by mixing a solution of polyamide in a suitable solvent and a liquid phase in which polyamides are insoluble. The liquid phase is usually water-based, in which case, by means of other suitable solvents, a clear solution can initially be achieved when the liquids are mixed, from which the polyamide particles precipitate. During production, in particular, mixing ratios of polyamide solution to liquid phase of 1:999 to 300:700, preferably 2:998 to 250:750, have proven useful.

Polyamide solutions can be prepared, for example, with the solvents o-cresol, m-cresol, p-cresol, chlorophenol, phenol or mixtures thereof. Formic acid has also proved useful.

The liquid phase in which polyamides are insoluble is preferably miscible with the above-mentioned solvents and, in addition, is water-miscible. Preferred liquid phases are aliphatic alcohols, aliphatic ketones and mixtures of these. Methanol, ethanol, n-propanol, isopropanol, acetone, methyl ethyl ketone, methyl isopropyl ketone, methyl isobutyl ketone and mixtures of these have proved particularly useful.

Preferably, mixtures of 10 to 98 wt. % aliphatic alcohols and/or ketones with 2 to 90 wt. % water can be used as the liquid phase from which the polyamide particles precipitate. For nucleation purposes, the liquid phase can contain high-molecular-weight polyalkylene glycols, e.g. PEG or PPG, in quantities of 0.5 to 10 wt. % (based on the liquid phase).

The mixing sequence is not critical for the production method. In preferred methods,
aliphatic alcohols and/or ketones and water are added simultaneously but separately from one another to a polyamide solution; or
a previously prepared mixture of aliphatic alcohols and/or ketones and water is added to a polyamide solution; or
aliphatic alcohols and/or ketones are added to a polyamide solution, after which water is added; or
water is added to a polyamide solution, after which aliphatic alcohols and/or ketones are added; or
a polyamide solution is added to a previously prepared mixture of aliphatic alcohols and/or ketones and water; or
a polyamide solution is added to aliphatic alcohols and/or ketones and water and then water is added.

Formation of the porous polyamide particles by precipitation takes place within one second to two hours and can be supported by stirring. Mixing of the liquids and formation of the particles preferably takes place at temperatures of 5 to 70° C., particularly preferably at 15 to 60° C.

After the above-mentioned period, the polyamide particles can be readily separated from the solvent mixture by decantation, filtration or centrifugation. This is preferably followed by washing with methanol and/or acetone and drying in vacuo.

Most particularly preferred methods of production utilize a solution of polyamide 11 and/or polyamide 12 in phenol, which contains 0.1 to 50 wt. % polyamide(s) based on its weight. In these preferred methods, a mixture of ethanol (preferably 50 to 90 wt. % based on the liquid phase), ethylene glycol (preferably 1 to 10 wt. % based on the liquid phase) and glycerol (preferably 1 to 12 wt. % based on the liquid phase) is preferably used as the liquid phase.

The polyamide solution in phenol (preferably 30 to 70 wt. % based on the mixture), the liquid phase (preferably 40 to 65 wt. % based on the mixture) and polyethylene glycol and/or polypropylene glycol with molar masses of >1000 Dalton (preferably 0.5 to 10 wt. % based on the mixture) are stirred together to form a mixture containing 0.05 to 20 wt. % polyamide(s).

This mixture, which ideally has a viscosity of less than 200 Pas, is stirred at 20 to 80° C., preferably at 25 to 65° C., for 30 to 60 minutes.

The spherical porous polyamide particles produced by the methods described above generally possess number-average particle diameters of 0.1 to 100 μm, preferably from 0.3 to 50 μm, in particular from 0.5 to 25 μm. The ratio of volume-average particle diameter (Dv) to number-average particle diameter (Dn), which is also known as the particle size distribution index (PDI=Dv/Dn), is preferably within the range of 1.0 to 1.5, preferably from 1.0 to 1.3.

The spherical porous polyamide particles possess a BET specific surface area (in accordance with DIN 66131) of 5 m²/g or more. Particularly preferred particles have a BET specific surface area (in accordance with DIN 66131) of 5 to 80 m²/g, preferably from 6 to 60 m²/g and in particular from 7.5 to 50 m²/g. Most particularly preferred agents according to the invention are characterized in that the spherical porous polyamide particles have a BET specific surface area (in accordance with DIN 66131) of 6 m²/g or more, preferably of 7 m²/g or more and in particular of 8 m²/g or more.

Preferred porous polyamide particles possess a porosity index (RI=S/S0, wherein S0 is the specific surface area, based on the number-average particle diameter and by the formula S0=6/(p*Dn) in which p is the density of the particles and Dn is the number-average particle diameter, and wherein S is the BET specific surface area) in the range of 3 to 100, preferably in the range of 5 to 70. The spherical porous polyamide particles possess an average pore diameter of 0.01 to 0.20 μm, preferably 0.02 to 0.1 μm, and a crystallinity (DSC measurement) of 40% or higher.

The standard enthalpy (or specific heat of fusion) of the spherical porous polyamide particles is measured by DSC. In this method, the sample is heated under a nitrogen atmosphere starting from room temperature (20° C.) at a rate of temperature increase of 5° C./min. The standard enthalpy is calculated from the area of the heat absorption peak between 120° C. and 230° C. The crystallinity of the spherical porous polyamide particles is the quotient of the specific heat of fusion measured and the standard enthalpy of crystalline polyamide, the latter being 12,209 J/g for polyamide.

With regard to the oil absorption capacity of the particles used in agents according to the invention, agents in which the spherical porous polyamide particles have an oil absorption capacity (boiled linseed oil) of 160 ml/100 g or more, preferably of 170 ml/100 g or more, are preferred.

Polyamide particles contained in agents according to the invention can preferably be loaded with a liquid, preferably comprising—
i. fragrances (perfume oils);
ii. liquid washing and cleaning agent ingredients, such as preferably surfactants, in particular nonionic surfactants, silicone oils, paraffins;
iii. liquid non-pharmaceutical additives or active substances (e.g., oils such as almond oil), mixtures of the above.

It is most preferred, however, for fragrances (perfume oils) to be contained in the polyamide particles. Loading of the polyamide particles can take place, for example, by simply mixing the polyamide particles with the desired quantity of the desired liquid (e.g., perfume oil).

As fragrances or perfume oils, all substances and mixtures known for this purpose may be used. Within the meaning of this invention, the terms “fragrance(s)” and “perfume oil(s)” are used synonymously. They mean in particular all those substances or mixtures thereof which are perceived by humans and animals as an odor, particularly by humans as a pleasant odor. As perfume oils, for example, individual fragrance compounds (e.g., the synthetic products of the ester, ether, aldehyde, ketone, alcohol and hydrocarbon types) may be used. Fragrance Compounds of the ester type include benzyl acetate, phenoxyethyl isobutyrate, p-tert.-butyl cyclohexyl acetate, linalyl acetate, dimethylbenzylcarbinyl acetate, phenyl ethyl acetate, linalyl benzoate, benzyl formate, ethyl methyl phenyl glycinate, allyl cyclohexyl propionate, styrallyl propionate and benzyl salicylate. Ethers include benzyl ethyl ether; aldehydes include linear alkanals with 8-18 C atoms, citral, citronellal, citronellyl oxyacetaldehyde, cyclamen aldehyde, hydroxycitronellel, lilial and bourgeonal; ketones include ionones, isomethyl ionone and methyl cedryl ketone; alcohols include anethole, citronellol, eugenol, geraniol, linalool, phenyl ethyl alcohol and terpineol; and hydrocarbons include mainly the terpenes and balsams. Preferably, however, mixtures of different fragrances are used, which together produce an attractive perfume note. The perfume oils may of course also contain natural fragrance mixtures, as obtainable from plant or animal sources (e.g., pine, citrus, jasmine, lily, rose or ylang-ylang oil).

The polyamide particles, in particular the liquid contained therein, can preferably also contain one or more (preferably liquid) active skin-care and/or skin-protecting substances. Active skin-care substances refer to those active substances which impart a sensory and/or cosmetic advantage to the skin. Active skin-care substances are preferably selected from the following substances:
a) waxes, such as carnauba, spermaceti, beeswax, lanolin and/or derivatives thereof and others;
b) hydrophobic plant extracts;
c) hydrocarbons, such as squalenes and/or squalanes;
d) higher fatty acids, preferably those with at least 12 carbon atoms, for example lauric acid, stearic acid, behenic acid, myristic acid, palmitic acid, oleic acid, linoleic acid, linolenic acid, isostearic acid and/or polyunsaturated fatty acids and others;
e) higher fatty alcohols, preferably those with at least 12 carbon atoms, for example lauryl alcohol, cetyl alcohol, stearyl alcohol, oleyl alcohol, behenyl alcohol, cholesterol and/or 2-hexadecanol and others;
f) esters, preferably those such as cetyl octanoates, lauryl lactates, myristyl lactates, cetyl lactates, isopropyl myristates, myristyl myristates, isopropyl palmitates, isopropyl adipates, butyl stearates, decyl oleates, cholesterol isostearates, glycerol monostearates, glycerol distearates, glycerol tristearates, alkyl lactates, alkyl citrates and/or alkyl tartrates and others;
g) lipids, such as cholesterol, ceramides and/or saccharose esters and others;
h) vitamins, such as vitamins A, C and E, vitamin alkyl esters, including vitamin C alkyl ester, and others;
i) sun screens;
j) phospholipids;
k) derivatives of alpha-hydroxy acids;
l) fragrances;
m) germicides for cosmetics use, both synthetic, such as salicylic acid and/or others, and natural, such as neem oil and/or others;
n) silicones;
o) natural oils (e.g., almond oil);
   and mixtures of any of the above components.

Polyamide particles according to the invention can advantageously absorb very large quantities of liquids such as perfume oils, and yet remain free-flowing. These polyamide particles can, for example, readily absorb up to 100 wt. % (and more) perfume, wt. % based on the original polyamide particles without loading with liquid, and yet remain free-flowing. Even higher loads can be achieved while maintaining good powder properties. Loading of the polymer particles with liquid such as perfume oil can be adjusted at will. The polyamide particles can preferably be loaded with, for example, at least 20 wt. %, 30 wt. %, 40 wt. % or 50 wt. % of a liquid such as perfume oil, wt. % based on the original polyamide particles without loading with liquid. Advantageously, the polyamide particles can also be loaded with even greater quantities, for example, with at least 60 wt. %, 70 wt. %, 80 wt. % or 90 wt. % of a liquid such as perfume oil, wt. % based on the original polyamide particles without loading with liquid. The polyamide particles can even be loaded with still greater quantities, for example, with at least 100 wt. %, 120 wt. % or 150 wt. % of a liquid such as perfume oil, wt. % based on the original polyamide particles without loading with liquid.

Washing or cleaning agents within the meaning of this invention include, in particular—
a) textile washing agents;
b) textile after-treatment agents (such as preferably fabric softeners, fabric conditioner sheets, etc.); and
c) cleaning agents, particularly cleaners for hard surfaces (such as preferably all-purpose cleaners and specialty cleaning products, such as dishwashing agents, toilet cleaners) and cleaning auxiliaries.

Formulation of agents according to the invention is preferably guided by the needs of the end user. Agents according to the invention can therefore be present in solid, semi-solid, liquid, disperse, emulsified, suspended or gel form. Solid and liquid agents can be packed, for example, in sachets or (preferably self-dissolving) pouches, and in particular in multi-chamber pouches. The term liquid within the meaning of the invention also includes any dispersion of solids in liquids. Agents according to the invention can also be present as pastes, lotions or creams. Solid agents can be present, for example, as free-flowing powders, flakes, solid blocks, bars (e.g., bars of soap), spheres or sticks or tablets, in particular multi-layer tablets. Liquid agents according to the invention can also be multi-phase, and the phases can be arranged, for example, horizontally (i.e., one on top of another) or vertically (i.e., side by side).

If, therefore, the washing or cleaning agent according to the invention is a textile washing agent, a preferred embodiment of the invention is present. A textile washing agent containing—
a) surfactant(s) and/or builders,
b) 0.0001 to 10 wt. % fragrance(s),
c) 0.1 to 10 wt. % spherical porous polyamide particles, which have
a number-average particle diameter of 1 to 30 μm,
a BET specific surface area (in accordance with DIN 66131) of 5 m²/g or more,
an oil absorption capacity (boiled linseed oil) of 160 ml/100 g or more,
a crystallinity (DSC measurement) of 40% or higher, and
a quotient of volume-average particle diameter to number-average particle diameter of 1.0 to 1.5,
   wt. % based on total weight of the agent, corresponds to a preferred embodiment of the invention.

A particular advantage of a textile washing agent according to the invention lies, for example, in the fact that the polyamide particles contained therein can be absorbed on to the laundry being washed during textile washing and can then release the liquid (e.g., perfume oil) incorporated therein slowly and over a prolonged period. As a result, an often desired “slow-release” or “long-lasting” effect can be achieved. The washed laundry has a uniform fragrance over a prolonged period. Likewise, other incorporated liquids such as skin-care oils or other active substances can also be released slowly. Furthermore, the polyamide particles can adsorb unpleasant odors, particularly after being deposited on laundry.

It is particularly preferred for textile washing agents according to the invention to contain anionic, nonionic and/or cationic surfactants, in particular a mixture of anionic and nonionic surfactants, the total agent containing preferably 0.1 to 50 wt. %, in particular 10 wt. % to 40 wt. % surfactant. This corresponds to a preferred embodiment of the invention and permits optimum cleaning performances. Preferred surfactants to be used will be described in more detail below.

It is particularly favorable if the textile washing agent according to the invention contains alkylbenzene sulfonate, preferably linear alkylbenzene sulfonate (LAS), advantageously in quantities of 0.1-25 wt. %, more advantageously 1-20 wt. %, e.g. in quantities of 5-15 wt. %, based on the total agent. This corresponds to a preferred embodiment of the invention and permits most particularly advantageous cleaning performances. If the textile washing agent according to the invention contains alkyl sulfate, in particular C₁₂-C₁₈ fatty alcohol sulfate, advantageously in quantities of 0.1-25 wt. %, more advantageously 1-20 wt. %, e.g. in quantities of 5-15 wt. %, based on the total agent, a preferred embodiment of the invention is present.

Other suitable anionic surfactants that can also be used are e.g. alkane sulfonates (e.g. secondary C13-C18 alkane sulfonate), methyl ester sulfonates (e.g. α-C12-C18 methyl ester sulfonate) and a-olefin sulfonates (e.g. α-C14-C18 olefin sulfonate) and alkyl ether sulfates (e.g. C12-C14 fatty alcohol-2EO-ether sulfate) and/or soaps. However, FAS and/or LAS are particularly suitable.

The anionic surfactants, including soaps, can be present in the form of their sodium, potassium or ammonium salts and as soluble salts of organic bases, such as mono-, di- or triethanolamine. The anionic surfactants are preferably present in the form of their sodium or potassium salts, in particular in the form of the sodium salts.

If the textile washing agent according to the invention comprises nonionic surfactant, in particular alkoxylated fatty alcohol, in particular in quantities of 0.01-30 wt. %, based on total agent, a preferred embodiment of the invention is again present. The combined use of alkylbenzene sulfonate with nonionic surfactant is most particularly preferred. Other suitable nonionic surfactants include alkyl phenol polyglycol ethers (APEO), (ethoxylated) sorbitan fatty acid esters (sorbitans), alkyl polyglucosides (APG), fatty acid glucamides, fatty acid ethoxylates, amine oxides, ethylene oxide-propylene oxide block polymers, polyglycerol fatty acid esters and/or fatty acid alkanolamides. Sugar-based nonionic surfactants such as APG are particularly preferred.

According to another preferred embodiment of the invention, the textile washing agent according to the invention comprises enzymes, preferably amylase, pectinase, carboanhydrase, tannase, lipase, mannanase, protease and/or cellulase, advantageously in quantities of 0.0001-5 wt. %, based on total agent. A suitable minimum quantity can also be 0.001 wt. % or 0.01 wt. %, based on total agent. Preferred enzymes to be used are described in greater detail below.

In addition, it is most particularly preferred for the textile washing agent according to the invention to contain a builder system, preferably a zeolite-containing builder system, preferably encompassing zeolite in quantities of >5 wt. %, more advantageously >10 wt. %, still more advantageously >15 wt. %, in particular ≧20 wt. %, wt. % based on the total agent. A sensible upper limit of zeolite can be, for example, 60 wt. %, 50 wt. % or 40 wt. %, based on total agent. This corresponds to a preferred embodiment of the invention. Within the meaning of the invention, the term “builder system” also includes those “systems” which consist of only a single builder such as zeolite. However, it is preferred for at least 2 substances with builder action to be used (e.g., zeolite in combination with soda or similar). It is also particularly preferred if the textile washing agent according to the invention contains a soluble builder system, preferably encompassing soda, silicate, citrate and/or polycarboxylates, advantageously in quantities of 0.1-50 wt. %, based on the total agent. This corresponds to a preferred embodiment of the invention. If such a soluble builder system is contained, it is highly preferable for only small quantities of insoluble builders such as zeolite (e.g., <5 wt. % to 0.1 wt. %) to be contained and in particular for no insoluble builder at all to be contained in this case. It is also possible for the textile washing agent according to the invention to contain a builder system that contains phosphates, in which case phosphate is preferably contained in quantities of 1-40 wt. %, in particular 5-30 wt. %, based on total agent. According to another preferred embodiment, however, the textile washing agent according to the invention is phosphate-free.

The textile washing agent according to the invention can, according to another preferred embodiment of the invention, be present in liquid or solid form, but preferably in solid form, and in particular it can be in powder or granule form, advantageously in the form of a shaped article, in particular in tablet form.

The textile washing agent according to the invention, according to another preferred embodiment of the invention, is distinguished by the fact that the spherical porous polyamide particles contained are loaded with a liquid, preferably a hydrophobic liquid, in particular comprising fragrances.

Textile washing agents according to the invention, which can be present, for example, as powdered solids, in compressed particle form, as homogeneous solutions or suspensions, can also in principle contain all known ingredients that are conventional in agents of this type. Agents according to the invention can, as already shown, contain builder substances, surface-active surfactants, and also bleaching agents, bleach activators, water-miscible organic solvents, enzymes, sequestering agents, electrolytes, pH-regulators and other auxiliary substances, such as optical brighteners, fluorescent agents, graying inhibitors, shrinkage inhibitors, anti-wrinkle agents, color transfer inhibitors, antimicrobial active substances, germicides, fungicides, antioxidants, preservatives, corrosion inhibitors, antistatic agents, bittering agents, ironing aids, proofing and impregnating agents, swelling and antislip agents, neutral filler salts and UV absorbers, foam regulators as well as dyes and fragrances.

Textile washing agents according to the invention preferably contain, as already described, one or more surfactants, with anionic surfactants, nonionic surfactants and mixtures thereof in particular, but also cationic, zwitterionic and amphoteric surfactants, being suitable.

A textile washing agent according to the invention can preferably contain at least one water-soluble and/or water-insoluble, organic and/or inorganic builder. Builder substances can be contained in the textile washing agents according to the invention preferably in quantities of up to 75 wt. %, in particular 5 wt. % to 50, wt. % based on the total agent.

Suitable bleaching agents to be considered for use in textile washing agents according to the invention include per oxygen compounds such as organic per acids, or per acid salts of organic acids, such as phthalimidopercaproic acid, perbenzoic acid or salts of diperdodecanedioic acid, hydrogen peroxide and inorganic salts which give off hydrogen peroxide under the washing conditions, which include perborate, percarbonate, persilicate and/or persulfate, such as Caroat. Where solid per oxygen compounds are to be employed, these can be used in the form of powders or granules, which can also be coated in a manner that is known in principle. If an agent according to the invention contains per oxygen compounds, these are present in quantities of preferably up to 50 wt. %, in particular from 5 wt. % to 30 wt. %. The addition of small quantities of known bleaching agent stabilizers such as phosphonates, borates or metaborates and metasilicates, as well as magnesium salts such as magnesium sulfate, may be useful.

Compounds which, under perhydrolysis conditions, produce aliphatic peroxocarboxylic acids with preferably 1 to 10 C atoms, in particular 2 to 4 C atoms, and/or optionally substituted perbenzoic acid can be used as bleach activators. Substances which carry O- and/or N-acyl groups with the above number of C atoms and/or optionally substituted benzoyl groups are suitable. Polyacylated alkylenediamines, in particular tetraacetyl ethylenediamine (TAED), are preferred.

Organic solvents suitable for use in the textile washing agents according to the invention, in particular if they are present in liquid or paste form, include, in addition to water, alcohols with 1 to 4 C atoms, in particular methanol, ethanol, isopropanol and tert-butanol, diols with 2 to 4 C atoms, in particular ethylene glycol and propylene glycol, as well as mixtures thereof and ethers that can be derived from the above classes of compounds. These water-miscible solvents are optionally present in the agents according to the invention preferably in quantities of no more than 30 wt. %, in particular from 6 wt. % to 20 wt. %.

Particularly when used in machine methods, it may be advantageous to add conventional foam inhibitors to the textile washing agents. Suitable foam inhibitors include soaps of natural or synthetic origin having a high proportion of C₁₈-C₂₄ fatty acids. To avoid the destruction of certain washing agent ingredients catalyzed by heavy metals, substances which complex heavy metals may be used. Suitable heavy metal complexing agents include the alkali salts of ethylenediamine tetraacetic acid (EDTA) or nitrilotriacetic acid (NTA), as well as alkali metal salts of anionic polyelectrolytes such as polymaleates and polysulfonates.

Solid textile washing agents can additionally contain neutral filler salts such as sodium sulfate. Liquid textile washing agents can additionally contain thickeners, for example, to establish a desired viscosity. Suitable thickeners that can be used are also described below in connection with textile after-treatment agents. The thickeners mentioned there can also be used in liquid textile washing agents.

Production of solid textile washing agents according to the invention offers no difficulties and can take place in known manners, for example, by spray-drying or granulation, with enzymes and any other heat-sensitive ingredients such as bleaching agents, optionally being added separately later. Incorporation of polyamide particles to be used according to the invention can occur, for example, by mixing them separately into the otherwise “finished” textile washing agent. In order to produce agents according to the invention with a relatively high bulk density, particularly in the range of 650 g/l to 950 g/l, a method involving an extrusion step is preferred.

Liquid or paste-like agents according to the invention in the form of conventional solvent-containing solutions are generally produced by simply mixing the ingredients, which can be charged into an automatic mixer as a pure substance or a solution.

A preferred powdered all-purpose washing agent according to the invention can, in addition to the polyamide particles according to the invention, contain components selected from the following:
anionic surfactants such as alkylbenzene sulfonate, alkyl sulfate, in quantities of, for example, 0-40 wt. %, advantageously 5-30 wt. %, preferably 8-15 wt. %, in particular 15-20 wt. %,
nonionic surfactants such as fatty alcohol polyglycol ether, alkyl polyglucoside, fatty acid glucamide, in quantities of e.g. 0-30 wt. %, advantageously 0.1-20 wt. %, preferably 2-15 wt. %, in particular 6-11 wt. %,
builders such as zeolite, polycarboxylate, sodium citrate, in quantities of e.g. 0-70 wt. %, advantageously 5-60 wt. %, preferably 10-55 wt. %, in particular 15-40 wt. %,
alkalis such as sodium carbonate, in quantities of e.g. 0-35 wt. %, advantageously 1-30 wt. %, preferably 2-25 wt. %, in particular 5-20 wt. %,
bleaching agents such as sodium perborate, sodium percarbonate, in quantities of e.g. 0-30 wt. %, advantageously 5-25 wt. %, preferably 10-20 wt. %,
corrosion inhibitors such as sodium silicate, in quantities of e.g. 0-10 wt. %, advantageously 1-6 wt. %, preferably 2-5 wt. %, in particular 3-4 wt. %,
stabilizers such as phosphonates, advantageously 0-1 wt. %,
foam inhibitors such as soap, silicone oils, paraffins, advantageously 0-4 wt. %, preferably 0.2-3 wt. %, in particular 1-1 wt. %,
enzymes such as proteases, amylases, cellulases, lipases, advantageously 0-2 wt. %, preferably 0.2-1 wt. %, in particular 0.3-0.8 wt. %,
graying inhibitors such as carboxymethyl cellulose, advantageously 0-1 wt. %,
discoloration inhibitors such as polyvinylpyrrolidone derivatives, advantageously 0-2 wt. %,
fillers such as sodium sulfate, advantageously 0-20 wt. %,
optical brighteners such as stilbene derivative, biphenyl derivative, advantageously 0.1-0.3 wt. %, in particular 0.1-0.4 wt. %,
fragrances,
water,
soap,
bleach activators,
cellulose derivatives,
soil repellents,
   wt. % based on total weight of the agent.

A preferred liquid all-purpose washing agent according to the invention can, in addition to the polyamide particles according to the invention, contain components selected from the following:
anionic surfactants such as alkylbenzene sulfonate, alkyl sulfate, in quantities of e.g. 0-40 wt. %, advantageously 5-40 wt. %, preferably 8-30 wt. %, in particular 15-25 wt. %;
nonionic surfactants such as fatty alcohol polyglycol ether, alkyl polyglucoside, fatty acid glucamide, in quantities of e.g. 0-30 wt. %, advantageously 0.1-25 wt. %, preferably 5-20 wt. %, in particular 10-15 wt. %;
builders such as zeolite, polycarboxylate, sodium citrate, advantageously 0-15 wt. %, preferably 0.01-10 wt. %, in particular 0.1-5 wt. %;
foam inhibitors such as soap, silicone oils, paraffins, in quantities of e.g. 0-10 wt. %, advantageously 0.1-4 wt. %, preferably 0.2-2 wt. %, in particular 1-3 wt. %;
enzymes such as proteases, amylases, cellulases, lipases, in quantities of e.g. 0-3 wt. %, advantageously 0.1-2 wt. %, preferably 0.2-1 wt. %, in particular 0.3-0.8 wt. %;
optical brighteners such as stilbene derivative, biphenyl derivative, in quantities of e.g. 0-1 wt. %, advantageously 0.1-0.3 wt. %, in particular 0.1-0.4 wt. %;
fragrances;
stabilizers;
water;
soap, in quantities of e.g. 0-25 wt. %, advantageously 1-20 wt. %, preferably 2-15 wt. %, in particular 5-10 wt. %; and
alcohols/solvents, advantageously 0-25 wt. %, preferably 1-20 wt. %, in particular 2-15 wt. %;
   wt. % based on total weight of the agent.

The present invention also provides a textile washing method using a textile washing agent according to the invention (as described above), wherein the washing temperature is ≦60° C., preferably ≦40° C.

The present invention also provides for use of spherical porous polyamide particles having—
a number-average particle diameter of 1 to 30 μm,
a BET specific surface area (in accordance with DIN 66131) of 5 m²/g or more,
an oil absorption capacity (boiled linseed oil) of 160 ml/100 g or more,
a crystallinity (DSC measurement) of 40% or higher, and
a quotient of volume-average particle diameter to number-average particle diameter of 1.0 to 1.5,
   as carriers for liquid active substances, such as fragrances, in textile washing agents,

According to a preferred embodiment, this use is intended for the retarded or delayed release of liquid active substances such as fragrances in textile washing. If the washing or cleaning agent according to the invention is a textile after-treatment agent, another preferred embodiment of the invention is present.

Accordingly, a textile after-treatment agent containing—
a) surfactant(s) and/or builders;
b) 0.0001 to 10 wt. % fragrance(s); and
c) 0.1 to 10 wt. % spherical porous polyamide particles having
a number-average particle diameter of 1 to 30 μm,
a BET specific surface area (in accordance with DIN 66131) of 5 m²/g or more,
an oil absorption capacity (boiled linseed oil) of 160 ml/100 g or more,
a crystallinity (DSC measurement) of 40% or higher, and
a quotient of volume-average particle diameter to number-average particle diameter of 1.0 to 1.5,
   wt. % based on total weight of the agent, corresponds to a preferred embodiment of the invention.

Textile after-treatment agents encompassed by the invention include fabric softeners, also known as lubricants or fabric conditioners, and their corresponding sheets for tumble-dryer application. A particular advantage of a textile after-treatment agent according to the invention, in particular a fabric softener, lies in the fact that the polyamide particles contained therein can be absorbed on to the laundry being washed during textile washing, and afterwards can release the liquid (e.g., perfume oil) incorporated therein slowly and over a prolonged period. As a result, an often desired “slow-release” or “long-lasting” effect is made possible. The washed laundry has a uniform fragrance over a prolonged period. Other incorporated liquids such as skin-care oils or other active substances can also be released slowly. In addition, the polyamide particles can adsorb unpleasant odors, particularly after being deposited on the laundry.

The textile after-treatment agent according to the invention can be present in solid form, preferably as a powder or granules, advantageously in the form of a shaped article, in particular in tablet form, or can be present in liquid form. The textile after-treatment agent according to the invention can also be a conditioner substrate. Preferred conditioner substrates are so-called tumble-dryer sheets, i.e. sheets for laundry care in the tumble dryer which preferably contain a softening component and perfume.

The textile after-treatment agents according to the invention are preferably fabric softeners (i.e., textile after-treatment agents that contain a softening component). Preferred active substances contained in fabric softener formulations according to the invention include cationic surfactants, in particular, ester quats. Ester quats are quaternary ammonium compounds with preferably two hydrophobic residues, each containing an ester group as a so-called predetermined breaking point for easier biodegradation.

If, therefore, the textile after-treatment agent according to the invention contains a softening compound, wherein the quantity of softening compound is preferably 5 to 80 wt. %, advantageously 6 to 40 wt. %, more preferably 7 to 20 wt. % and in particular 8 to 15 wt. %, based in each case on the total agent, a preferred embodiment of the invention is present. If a cationic surfactant is contained, advantageously a quaternary ammonium compound, in particular an ester quat, preferably in quantities of >0.1 wt. %, advantageously 1 to 40 wt. %, in particular 3 to 30 wt. %, based on the total agent, another preferred embodiment of the invention is present.

After-treatment agents are usually brought into contact with the textiles in the final step of a conventional textile washing operation, the rinse cycle. The after-treatment can also take place in the tumble dryer, particularly by using the above-mentioned tumble-dryer sheets.

The softening component comprises, for example, quaternary ammonium compounds such as monoalk(en)yl trimethylammonium compounds, dialk(en)yl dimethylammonium compounds, mono-, di- or triesters of fatty acids with alkanolamines. Particularly preferred softening components are alkylated quaternary ammonium compounds, in which at least one alkyl chain is interrupted by an ester group and/or amido group. Most particularly preferred are N-methyl-N-(2-hydroxyethyl)-N,N-(ditallow acyloxyethyl)ammonium methosulfate or bis(palmitoyloxyethyl)hydroxyethyl methylammonium methosulfate.

Textile after-treatment agents, particularly in the form of fabric softeners, can also contain nonionic softening components such as polyoxyalkylene glycerol alkanoates, polybutylenes, long-chain fatty acids, ethoxylated fatty acid ethanolamides, alkyl polyglucosides, in particular, sorbitan mono-, di- and triesters, and fatty acid esters of polycarboxylic acids.

In the textile after-treatment agent according to the invention, particularly a fabric softener, the softening component is present in amounts of preferably 0.1 to 80 wt. %, generally 1 to 40 wt. %, preferably 2 to 20 wt. % and in particular 3 to 15 wt. %, based on total weight of the textile after-treatment agent.

A preferred textile after-treatment agent, particularly in the form of a fabric softener, contains essential oil and a cationic softening component with two fatty alkyl residues. In a textile after-treatment agent of this type, the cationic softening component not only acts as a textile softener but also supports the deposition of the essential oil on to the textile fabrics.

In a preferred embodiment of the invention, a textile after-treatment agent according to the invention contains an emulsifier, preferably a nonionic surfactant, in particular encompassing alkoxylated fatty alcohol and/or alkyl glycoside.

As another component, the textile after-treatment agents according to the invention, particularly in the form of fabric softeners, can therefore optionally contain one or more nonionic surfactants, it being possible to use those conventionally also employed in washing agents.

100701 The textile after-treatment agent can furthermore contain at least one aromatherapy component. An essential oil can preferably be used as an aromatherapy component. Essential oils also fall within the generic term of fragrances. The quantity of essential oil in the textile after-treatment agent is preferably from 0.0001 to 3 wt. %, particularly preferably from 0.01 to 1 wt % and most particularly preferably from 0.05 to 0.5 wt. %.

According to another preferred embodiment of the invention, textile after-treatment agents according to the invention are distinguished by the fact that the spherical porous polyamide particles contained are loaded with a liquid, preferably a hydrophobic liquid, particularly comprising fragrances and/or cosmetic active substances such as skin-/bodycare, antibacterial and/or deodorizing substances.

In addition to the surfactants and/or softening compounds, the textile after-treatment agents can contain other ingredients which further improve the application and/or esthetic properties of the textile after-treatment agent. Within the framework of the present invention, preferred textile after-treatment agents additionally contain one or more substances from the group of builders, bleaching agents, bleach activators, enzymes, electrolytes, non-aqueous solvents, pH-adjusting agents, perfumes, perfume carriers, fluorescent agents, dyes, hydrotopes, foam inhibitors, silicone oils, antiredeposition agents, optical brighteners, graying inhibitors, shrinkage inhibitors, anti-wrinkle agents, color transfer inhibitors, antimicrobial active substances, germicides, fungicides, antioxidants, preservatives, corrosion inhibitors, antistatic agents, bittering agents, ironing aids, proofing and impregnating agents, swelling and anti-slip agents, neutral filler salts and UV absorbers.

A liquid textile after-treatment agent can contain a thickener. The thickener can comprise, for example, a polyacrylate thickener, xanthan gum, gellan gum, guar gum, alginate, carrageenan, carboxymethyl cellulose, bentonites, wellan gum, locust bean gum, agar-agar, tragacanth, gum arabic, pectins, polyoses, starch, dextrins, gelatins and casein. However, modified natural substances such as modified starches and celluloses can also be used as thickeners, examples being carboxymethyl cellulose and other cellulose ethers, hydroxyethyl and hydroxypropyl cellulose and gum ethers.

Non-aqueous solvents that can be used in the liquid textile after-treatment agents come for example from the group of the mono- or polyhydric alcohols, alkanolamines or glycol ethers, provided that they are miscible with water in the concentration range stated. The pH of the liquid textile after-treatment agent, in particular in the form of a fabric softener, is preferably between 1 and 6 and preferably between 1.5 and 3.5.

In a preferred embodiment, the textile after-treatment agent contains one or more perfumes in quantities of up to 10 wt. %, preferably 0.01 to 5 wt. %, in particular 0.05 to 5 wt. %, particularly preferably 0.1 to 3 wt. % and most preferably 0.4 to 0.8 wt. %. The quantity of perfume used also depends on the type of textile after-treatment agent. As perfume oils or fragrances, for example, individual fragrance compounds (e.g., the synthetic products of ester, ether, aldehyde, ketone, alcohol and hydrocarbon types), can be used. Preferably, however, mixtures of different fragrances are used which together produce an attractive perfume note. These perfume oils may also contain natural fragrance mixtures, obtainable from plant sources.

In addition, textile after-treatment agents according to the invention can be used for the treatment of textile fabrics which impart an advantage to skin upon contact therewith. The production of the textile after-treatment agents can take place using techniques familiar to the person skilled in the art. This can be achieved e.g. by mixing the raw materials, optionally using high-shear mixing equipment. It is recommended to melt the softening component(s) preferably contained and subsequently to disperse the melt in a solvent, preferably water. The other ingredients can be integrated simply by admixing them. The polyamide particles can, for example, be dispersed or mixed into the otherwise finished product in a final step.

A preferred textile after-treatment agent according to the invention comprises, in addition to the polyamide particles according to the invention,—
a) softening compounds, advantageously cationic surfactants, preferably ester quats, advantageously in quantities of 5-30 wt. %, e.g. 10-20 wt. %;
b) emulsifiers, preferably nonionic surfactants, e.g. fatty alcohol ethoxylates, advantageously in quantities of 0-5 wt. %, e.g. 0.1-3 wt. %;
c) preservatives, advantageously in quantities of 0-2 wt. %, e.g. 0.001-0.5 wt. %;
d) fragrances, preferably in quantities of 0-10 wt. % or 0-5 wt. %, e.g. 0.01-1 wt. %;
e) dyes, advantageously in quantities of 0-0.1 wt. %, e.g. 0.01-0.005 wt. %;
f) optionally water, preferably in quantities >50 wt. % or >60 wt. %, e.g. 70-95 wt. % or e.g. 75-90 wt. %;
g) optionally solvents, preferably monohydric alcohols, in particular 2-propanol, advantageously in quantities of 0.05 to 5 wt. %, in particular 0.1 to 4 wt. %, in particular 0.3 to 3 wt. %;
h) optionally pH-adjusting agents, preferably 0.01 to 5 wt. %, in particular 0.02 to 1 wt. %;
i) optionally electrolytes, preferably from the group of the inorganic salts, advantageously MgCl2 or NaCI, 0.01 to 5 wt. %, in particular 0.05 to 2 wt. %;
j) optionally active skincare substances, such as e.g. almond oil, preferably in a quantity of 0 to 15 wt. %, advantageously 0.1-10 wt. %, in particular 0.5 to 5 wt. %;
k) optionally thickeners, e.g. polyacrylate-based, preferably in quantities of 0.01 to 3 wt. %, in particular 0.1 to 1 wt. %;
   wt. % based in each case on the total agent.

The present invention also provides a textile conditioning method using a textile after-treatment agent according to the invention (as described above) in the rinse cycle of an automatic washing machine.

The present invention also provides a textile conditioning method using a textile after-treatment agent according to the invention in the form of a conditioner substrate in an automatic tumble dryer.

The present invention also provides the use of a textile after-treatment agent according to the invention for the conditioning of textile fabrics.

The present invention also provides the use of spherical porous polyamide particles having—
a number-average particle diameter of 1 to 30 μm;
a BET specific surface area (in accordance with DIN 66131) of 5 m²/g or more;
an oil absorption capacity (boiled linseed oil) of 160 ml/100 g or more;
a crystallinity (DSC measurement) of 40% or higher; and
a quotient of volume-average particle diameter to number-average particle diameter of 1.0 to 1.5,
   as carriers for liquid active substances such as fragrances in textile after-treatment agents. If this use is intended for the delayed release of liquid active substances such as fragrances during treatment of textile fabrics in the context of textile conditioning, a preferred embodiment of the invention is present. If the use is for the finishing of textile fabrics with liquid active substances such as skin-protecting oils which impart an advantage to skin upon contact therewith, a preferred embodiment of the invention is also present.

A preferred embodiment of the invention is also present if the washing or cleaning agent according to the invention is a cleaning agent, particularly a hard surface cleaner. Consequently, a cleaner containing—
a) surfactant(s) and/or builders;
b) 0.0001 to 10 wt. % fragrance(s); and
c) 0.1 to 10 wt. % spherical porous polyamide particles having
   a number-average particle diameter of 1 to 30 μm,
   a BET specific surface area (in accordance with DIN 66131) of 5 m²/g or more,
   an oil absorption capacity (boiled linseed oil) of 160 ml/100 g or more,
   a crystallinity (DSC measurement) of 40% or higher, and
   a quotient of volume-average particle diameter to number-average particle diameter of 1.0 to 1.5,
      wt. % based in each case on the total agent, is a preferred embodiment of this invention. The terms “cleaner” and “cleaning agent” are used synonymously within the meaning of this invention. The most preferred cleaners include manual dishwashing agents and machine dishwashing agents. Preferred cleaners include, among others, toilet or WC cleaners (i.e., products for cleaning toilet bowls and urinals), preferably presented as powders, tablets, shaped articles or liquids, preferably gels. So-called toilet blocks are also suitable. In addition to other conventional ingredients such as surfactants, they mainly contain organic acids (e.g., citric acid and/or lactic acid) or sodium hydrogen sulfate, amidosulfuric acid or phosphoric acid to remove limescale deposits or so-called urine scale. In association with machine dishwashing agents, also included as cleaning auxiliary substances within the meaning of the present invention are fragrance release systems encompassing a container together with particles for deodorizing and fragrancing the dishwasher, these particles comprising fragrance-containing, spherical porous polyamide particles having
a number-average particle diameter of 1 to 30 μm;
a BET specific surface area (in accordance with DIN 66131) of 5 m²/g or more;
an oil absorption capacity (boiled linseed oil) of 160 ml/100 g or more;
a crystallinity (DSC measurement) of 40% or higher; and
a quotient of volume-average particle diameter to number-average particle diameter of 1.0 to 1.5,
   wt. % based in each case on the total agent. The spherical porous polyamide particles can also, in addition to fragrances, comprise builders and/or surfactants as well as other active substances, such as dyes, antimicrobial active substances, germicides, fungicides, antioxidants or corrosion inhibitors.

If, therefore, the cleaning agent according to the invention is chosen from manual dishwashing agents, machine dishwashing agents, toilet cleaners or WC cleaners, plughole cleaning agents or drain cleaners, universal or all-purpose cleaners, disinfectant cleaners, oven cleaners or grill cleaners, metal polishes, glass cleaners or window cleaners, cleaning auxiliary substances, floor cleaning agents and specialty cleaning agents, a preferred embodiment of the invention is present.

Also in connection with the cleaning agents, an advantage of the invention lies in enabling a delayed release of liquids such as fragrances from the polyamide particles contained. Thus, an often desired “slow-release” effect or “long-lasting” effect is made possible. The cleaned surface (e.g., a floor) has a uniform fragrance over a prolonged period. Likewise, other incorporated liquids such as liquids with antimicrobial active substances, germicides, fungicides or other active substances are released slowly. In addition, the polyamide particles can adsorb unpleasant odors after deposition on the surface (e.g., a floor).

In a preferred embodiment of the invention, a cleaning agent according to the invention contains builders, preferably selected from the group of the phosphates, carbonates and citrates, the proportion by weight of these builders, based on the total agent, advantageously being 1-60 wt. %, more advantageously 2 to 50 wt. %, preferably 5 to 40 wt. % and in particular 10 to 30 wt. %. In another preferred embodiment of the invention, a cleaning agent according to the invention contains an anionic polymer, advantageously in quantities of 0.2 to 30 wt. %, preferably 0.5 to 20 wt. % and in particular 1.0 to 12 wt. %, wt. % based on the total agent.

If a copolymer encompassing—
i. unsaturated carboxylic acid(s),
ii. sulfonic acid group-containing monomer(s), and
iii. other nonionic monomer(s)
   is contained as an anionic polymer, a preferred embodiment of the invention is again present.

If the cleaning agent according to the invention contains nonionic surfactant, advantageously in quantities of 0.1 to 15 wt. %, preferably 0.2 to 10 wt. %, particularly preferably 0.5 to 8 wt. % and in particular from 1.0 to 6 wt. %, wt. % based on the total agent, another preferred embodiment of the invention is present.

If the cleaning agent according to the invention contains enzyme, preferably encompassing amylase and/or protease, advantageously in quantities of 0.1 to 12 wt. %, preferably from 0.2 to 10 wt. % and in particular from 0.5 to 8 wt. %, wt. % based on the total agent, another preferred embodiment of the invention is present.

If the cleaning agent according to the invention contains phosphonate, preferably selected from—
a) aminotrimethylene phosphonic acid (ATMP) and/or salts thereof;
b) ethylenediamine tetra(methylene phosphonic acid) (EDTMP) and/or salts thereof;
c) diethylenetriamine penta(methylene phosphonic acid) (DTPMP) and/or salts thereof;
d) 1-hydroxyethane-1,1-diphosphonic acid (HEDP) and/or salts thereof;
e) 2-phosphonobutane-1,2,4-tricarboxylic acid (PBTC) and/or salts thereof;
f) hexamethylenediamine tetra(methylene phosphonic acid) (HDTMP) and/or salts thereof;
g) nitrilotri(methylene phosphonic acid) (NTMP) and/or salts thereof,
   another preferred embodiment of the invention is present.

If the cleaning agent according to the invention contains bleaching agents, such as preferably percarbonate, advantageously in quantities of 5-30 wt. %, in particular 10-20 wt. % based on the total agent, another preferred embodiment of the invention is present.

If the cleaning agent according to the invention is present in liquid or solid form, preferably in solid form, in particular powder or granules, advantageously in the form of a shaped article, in particular in tablet form, a preferred embodiment of the invention is likewise present. If the cleaning agent according to the invention is distinguished by the fact that the spherical porous polyamide particles contained are loaded with a liquid, preferably a hydrophobic liquid, in particular comprising fragrances and/or surface-care, antibacterial and/or deodorizing substances, a preferred embodiment of the invention is again present.

Cleaners according to the invention, particularly dishwashing agents according to the invention, preferably contain active washing or cleaning ingredients, with substances such as builders, surfactants, polymers, bleaching agents, bleach activators, enzymes, glass corrosion inhibitors, corrosion inhibitors, disintegration aids, fragrances and perfume carriers being particularly preferred.

According to the invention, cleaning agents, particularly machine dishwashing agents containing 1 to 35 wt. %, preferably 2.5 to 30 wt. %, particularly preferably 3.5 to 20 wt. % and in particular 5 to 15 wt. % bleaching agents, preferably sodium percarbonate, are preferred.

To increase the cleaning performance of cleaning agents, enzymes can be used. These include proteases, amylases, lipases, hemicellulases, cellulases, perhydrolases or oxidoreductases, and preferably mixtures thereof. These enzymes are in principle of natural origin; based on the natural molecules, improved variants are available for use in cleaning agents, which are correspondingly preferably used. Cleaning agents contain enzymes preferably in total quantities of 1×10⁻⁶ to 5 wt. %, based on active protein. The protein concentration can be determined by known methods (e.g., the BCA method or the biuret method). Preferably, one or more enzymes and/or enzyme preparations, preferably solid protease preparations and/or amylase preparations, are optionally used in quantities of 0.1 to 5 wt. %, preferably from 0.2 to 4.5 wt. % and in particular from 0.4 to 4 wt. %, each based on total enzyme-containing agent.

Formulation of cleaners according to the invention such as machine dishwashing agents can take place in various ways. Agents according to the invention can be present in solid or liquid form and as a combination of solid and liquid presentation forms. Suitable solid presentation forms include powders, granules, extrudates or compactates, in particular, tablets. The liquid presentation forms based on water and/or organic solvents can be present in thickened form as gels. Preferred manual dishwashing agents according to the invention can contain, in addition to the polyamide particles according to the invention, for example:
a) surfactants such as alkane sulfonates, alkyl ether sulfates, alkyl polyglucosides and/or cocamidopropyl betaine, preferably in quantities of 5-45 wt. %, in particular 10-40 wt. %;
b) optionally acidifying agents such as citric acid, to adjust the pH;
c) hydrotropes such as cumene sulfonate, preferably in quantities of 0 to 15, in particular 0.01 to 10 wt. %;
d) refatting agents such as fatty acid amides, preferably in quantities of 0 to 3 wt. %, in particular 0.01 to 3 wt. %;
e) care components such as aloe vera extracts, preferably in quantities of 0 to <5 wt. %, in particular 0.001 to <3 wt. %;
f) fragrances, preferably in quantities of 0 to 3 wt. %, in particular 0.01 to 2 wt. %;
g) optionally dyes;
h) antibacterial active substances such as sodium benzoate or sodium salicylate, preferably in quantities of 0 to 3 wt. %, in particular 0.001 to 2 wt. %; and
i) preservatives, for example, in quantities of 0 to 1 wt. %, in particular 0.001 to 0.5 wt. %.

Preferred machine dishwashing agents according to the invention can contain, in addition to the polyamide particles according to the invention, for example, sodium phosphates, preferably pentasodium triphosphate, phosphonates, citrates, preferably sodium citrate, polycarboxylates, sodium metasilicates, soda, sodium hydrogen carbonate, sodium disilicate, active chlorine, sodium perborate, bleach activator TAED, enzymes, preferably protease and amylase, low-foam nonionic surfactants, silver/glass protection and fragrances. Preferred machine dishwashing agents can be, for example, phosphate-based and highly alkaline, or phosphate-based and low-alkalinity. Other preferred machine dishwashing agents can be, for example, phosphate-free and low-alkalinity.

The present invention also provides a method for cleaning hard surfaces using a cleaning agent according to the invention, as described above, in conjunction with water. Another advantage of the invention is that unloaded polyamide particles can also adsorb fats and oils in washing water or on surfaces. The invention also provides the use of spherical porous polyamide particles having—
a number-average particle diameter of 1 to 30 μm,
a BET specific surface area (in accordance with DIN 66131) of 5 m²/g or more,
an oil absorption capacity (boiled linseed oil) of 160 ml/100 g or more,
a crystallinity (DSC measurement) of 40% or higher, and
a quotient of volume-average particle diameter to number-average particle diameter of 1.0 to 1.5,
   as a carrier for liquid active substances, such as fragrances, in cleaning agents.

The present invention also provides the use of spherical porous polyamide particles having—
a number-average particle diameter of 1 to 30 μm,
a BET specific surface area (in accordance with DIN 66131) of 5 m²/g or more,
an oil absorption capacity (boiled linseed oil) of 160 ml/100 g or more,
a crystallinity (DSC measurement) of 40% or higher, and
a quotient of volume-average particle diameter to number-average particle diameter of 1.0 to 1.5,
   to adsorb fats and oils in washing water or on surfaces during the use of cleaning agents. If this use is intended for the retarded release of liquid active substances, such as fragrances, surface-care, antibacterial and/or deodorizing substances, in the cleaning of hard surfaces, such as floors, glass, dishes, a preferred embodiment of the invention is present.

### EXAMPLES

The production of polyamide particles for use according to the invention is described below.

10.0 g ethylene glycol, 2.5 g PEG 1450 and 2.5 g PPG 3000 were added to 98.0 g phenol heated to 70° C. To this mixture, 2.0 g polyamide 12 (molar mass 14 kDa) were added. The mixture was stirred at 70° C. for 24 hours to dissolve all the polyamide. The resulting solution contained 1.74 wt. % polyamide.

An alcohol mixture was prepared from 14.0 g glycerol and 9.5 g ethylene glycol.

The two solutions were held at a temperature of 30° C. and mixed together while stirring and stirred for ten minutes (300 rpm). Immediately after stirring stopped, a viscosity of 36 mPas (30° C.) was measured. The mixture was held at a temperature of 30° C. for 24 hours. Approx. 90 minutes after the stirring operation stopped, the mixture became slightly cloudy and the precipitation of the polyamide particles began.

After 24 hours, the precipitated particles were separated off by filtration and washed with one liter of methanol. The washed particles were dried at 60° C. for 12 hours in vacuo.

The number-average particle diameter was 15.1 μm; the volume-average particle diameter was 15.4 μm; the particle size distribution index was 1.02; the specific surface area was measured as 5.4 m²/g; the porosity index was 15.1; the average pore diameter was 0.026 μm, and the crystallinity was 69%.

The polyamide particles could be readily loaded with large quantities of perfume oil and yet remained free-flowing. The polyamide particles loaded with perfume oil could be readily incorporated into various washing and cleaning agents, e.g. into powdered textile washing agents, liquid softeners and liquid all-purpose cleaners.

We claim:

1. Washing or cleaning agent comprising:
a) one or more surfactant(s) and/or builders;
b) 0.0001 to 10 wt. % of one or more fragrances; and
c) 0.1 to 10 wt. % of spherical porous polyamide particles having
a number-average particle diameter of 1 to 30 μm,
a BET specific surface area (in accordance with DIN 66131) of 5 m²/g or more,
an oil absorption capacity (boiled linseed oil) of 160 ml/100 g or more,
a crystallinity (DSC measurement) of 40% or higher, and
a quotient of volume-average particle diameter to number-average particle diameter of 1.0 to 1.5,
each wt. % based on total weight of the agent.

2. Agent according to claim 1, wherein the agent is a textile washing agent.

3. Agent according to claim 2 further comprising one or more anionic, nonionic and/or cationic surfactants in an amount of 0.1 wt. % to 50 wt. %, based on total weight of the agent.

4. Agent according to claim 3 wherein the surfactant is at least an alkylbenzene sulfonate present in an amount of 0.1-25 wt. %, based on total weight of the agent.

5. Agent according to claim 3 wherein the surfactant is at least a nonionic surfactant present in an amount of 0.01-30 wt. %, based on total weight of the agent.

6. Agent according to claim 2 further comprising one or more enzymes present in an amount of 0.0001-5 wt. %, based on total weight of the agent.

7. Agent according to claim 2 further comprising a zeolite-containing builder system present in an amount >5 wt. %, based on total weight of the agent.

8. Agent according to claim 2 further comprising a soluble builder system.

9. Agent according to claim 2 further comprising a phosphate-containing builder system, wherein phosphate is preferably contained in quantities of 1-40 wt. %, based on total weight of the agent.

10. Agent according to claim 2, wherein the agent has a pH >7.5, measured in a 5% solution of the agent in water at 20° C.

11. Agent according to claim 2, wherein the agent is present in solid form.

12. Agent according to claim 1, wherein the spherical porous polyamide particles are loaded with liquid comprising fragrances.

13. Textile washing method comprising washing textiles with an agent according to claim 2, wherein the washing temperature is ≦60° C.

14. Carrier for liquid active substances comprising:
spherical porous polyamide particles having
a number-average particle diameter of 1 to 30 μm,
a BET specific surface area (in accordance with DIN 66131) of 5 m²/g or more,
an oil absorption capacity (boiled linseed oil) of 160 ml/100 g or more,
a crystallinity (DSC measurement) of 40% or higher, and
a quotient of volume-average particle diameter to number-average particle diameter of 1.0 to 1.5.

15. Method of delaying the release of liquid active substances in textile washing comprising washing textiles with a detergent comprising the carrier according to claim 14, wherein the carrier is loaded with the liquid active substance.
